(19) United States
(12) Patent Application Publication
(10) Pub. No.: US 2026/0144274 A1
(43) Pub. Date: May 28, 2026

(54) CONFECTIONARY MASS RICH IN WHEY PROTEIN

(71) Applicant: FrieslandCampina Nederland B.V., Amersfoort (NL)

(72) Inventors: Aart Cornelis Alting, Ede (NL); Francisca Elisabeth Ellen Oosterveen, Driel (NL); Karlijn Johanna Margaretha Hol, Veenendaal (NL); Esther Theresia Van Der Meulen, Bennekom (NL)

(21) Appl. No.: 19/127,085

(22) PCT Filed: Nov. 1, 2023
(86) PCT No.: PCT/EP2023/080471

§ 371 Date: May 2, 2025

(30) Foreign Application Priority Data
Nov. 3, 2022 (EP) 22205319.1
Nov. 3, 2022 (EP) 22205322.5
Nov. 3, 2022 (EP) 22205323.3

(51) Int. Cl. A23G 3/46; A23G 3/40; A23G 3/42; A23G 3/44; A23L 33/185; A23L 33/19

(52) U.S. Cl. CPC A23G 3/46; A23G 3/40; A23G 3/42; A23G 3/44; A23L 33/185; A23L 33/19

(57) ABSTRACT

The present invention confectionary mass comprising microparticulated whey protein. This confectionary mass allows the production of nutritional bars with pleasant texture and taste and with a high whey protein content.

The present invention relates to a confectionary mass that is rich in whey protein.

Confectionary products such as food bars are made from confectionary masses, i.e. substances that can be subjected to a shaping process, such as rolling, extruding, depositing and removing from refrigerated drums, pressing, moulding, and the like. These masses generally are non-fluid but deformable at ambient temperature, at least until after having been shaped into a desired form, such as a bar. They typically have a dough-like consistency. Accordingly, they are also referred to in the art as ‘doughs’. After having been shaped, the consistency of the mass may change.

There is a current trend towards high protein food products; especially for elderly, sportsmen, and people with an active lifestyle. Commercial products supporting this trend include various high protein shakes, high protein yoghurts and quarks, and high protein food bars.

High protein confectionary products, such as food bars, often include dairy proteins; such as whey protein, casein, and/or caseinate. The taste and mouth feel of dairy proteins is generally considered neutral and pleasant.

Of the two main classes of dairy proteins—whey protein and casein—whey protein has the best nutritional value in terms of essential amino acids (especially leucine) and fast digestibility. Therefore, whey protein products are very popular for sportsmen and people with an active lifestyle.

The preparation of confectionary masses and food bars with a high whey protein content and good consistency is, however, difficult: the preparation of high protein bars with whey protein as the sole protein source results in bars with a rather tough texture, whereas replacement of part of the whey protein with casein significantly improves the texture, but at the expense of the nutritional value.

The object of the present invention is therefore the provision of a confectionary mass with a protein content of 26-40 wt %, wherein essentially all protein is whey protein and/or derived from whey protein sources.

This object is met by the confectionary mass according to the present invention, which comprises microparticulated whey protein.

The invention relates to a confectionary mass comprising:
10-70 wt % of one or more whey protein sources,
25-80 wt % of a binding material, preferably selected from carbohydrates and sugar alcohols, and
5-20 wt % of oil, preferably vegetable oil,
   wherein the total water content of the confectionary mass is in the range 5-30 wt %, at least 90 wt % of the total protein content is whey protein, and wherein the one or more whey protein sources are selected from whey protein concentrate, whey protein isolate, hydrolysed whey protein, and microparticulated whey protein, and wherein 30-100 wt % of the one or more whey protein sources is microparticulated whey protein.

This confectionary mass can be prepared by blending the one or more whey protein sources with the binder and the oil.

Microparticulated whey protein was first described in U.S. Pat. No. 4,734,287 which formed the basis for the commercial fat replacer Simplesse®. This material was offered for use in frozen desserts, cheese, dressings, and mayonnaise, and allowed a creamy texture despite the reduced fat content. It was produced by thermal aggregation of whey protein under high shear and low pH.

There appears to be no formal definition of the term ‘microparticulated whey protein’. Furthermore, there are various other terms for this same type of material, such as: heat-denatured whey protein particles, whey protein aggregates or microparticles, and heat-stable whey. Within the present specification, the term ‘microparticulated whey protein’ is defined as whey protein concentrate (WPC) or whey protein isolate (WPI) that has been subjected to heat treatment and high shear/mechanical forces, leading to small micron-sized whey protein particles/aggregates with a high degree of denaturation.

50 vol % of the particles/aggregates of microparticulated whey protein have a particle diameter in the range 0.05-20 microns, more preferably 0.05-10 microns, most preferably 0.05-1.0 microns. Generally, 90 vol % of the particles (D90) has a diameter of less than 60 microns, more preferably less than 10 microns, most preferably less than 5.0 microns. This particle diameter and size distribution are determined, after homogenization at 100 bar, using laser diffraction (Malvern Matersizer 2000), with a refractive index of 1.47, and assuming non-spherical particles with an adsorption of 0. Microparticulated whey protein has a degree of denaturation, defined as a total percentage of native alpha-lactalbumin and native beta-lactoglobulin, not higher than 40 wt %, preferably not higher than 30 wt %, more preferably not higher than 20 wt %, even more preferably not higher than 15 wt %, even more preferably not higher than 10 wt %, and most preferably not higher than 5 wt %, based on total protein. The remaining part of the total α-lactalbumin and β-lactoglobulin content being in denatured form. The extent of α-lactalbumin denaturation is preferably at least 30%, preferably at least 40, more preferably at least 50%, even more preferably at least 60%, and most preferably at least 70%. The extent of β-lactoglobulin denaturation is preferably at least 60%, preferably at least 70%, more preferably at least 75%, even more preferably at least 80%, and most preferably at least 85%.

The native α-lactalbumin and β-lactoglobulin content can be determined by means of high pressure gel permeation liquid chromatography, as described by C. Holt et al., Int. J. Food Sci. Techn. 34 (1999) 543-556, method 1 of BDI laboratory 1. To this end, the protein sample is dissolved in distilled water at approximately 2 g/l and the pH of the solution is adjusted to pH 4.6 with 0.5 M HCl. After 0.5 hour standing at ambient temperature, the sample is filtered using a 0.45 μm membrane and subsequently separated using a size exclusion (TSK G2000 SEXL) column, a pH 6.0 phosphate buffer, and detection at 280 nm. The concentration of native β-lactoglobulin and α-lactalbumin is determined by integration of the peak area. By comparing these concentrations with those of the starting whey protein material, the degree of denaturation can be calculated.

Whey protein concentrates (WPC) and whey protein isolates (WPI) are the result of separating skimmed milk into a casein-rich and a whey protein-rich fraction; either by renneting/cheese production (leading to cheese whey), acidification/caseinate production (leading to acid whey), or microfiltration/micellar casein isolation (leading to native whey), followed by membrane filtration, precipitation, and/or ion exchange techniques in order to remove a large part of the water, lactose, and ash, thereby concentrating the whey proteins.

WPCs conventionally have a protein content (based on dry matter) of about 60-85 wt %, whereas WPIs are manufactured by removing more of the non-protein components, thereby concentrating the whey protein to about 90-95 wt % or more.

Processes for the production of WPC or WPI may involve concentrating the entire protein fraction in the raw material, but may also include a selective enrichment in a particular protein. Examples thereof as WPCs and WPIs selectively enriched in either a-lactalbumin or b-lactoglobulin.

WPC and WPI generally have a protein content, based on dry matter, in the range 60-95 wt %, and a total percentage of native alpha-lactalbumin and beta-lactoglobulin, based on total protein, of at least 50 wt %, preferably at least 60 wt %, most preferably at least 70 wt %.

The proteins in WPC and WPI are essentially in native form.

Aqueous dispersions of WPCs or WPI with concentrations above about 2 wt % tend to gel upon heating, thereby affecting the rheology and texture of a food product. This may be desirable for some, but undesirable for other applications.

Like WPC and WPI, microparticulated whey protein preferably has a protein content, based on dry matter, of 60-95 wt %, but differs from WPC and WPI in that a large part of the proteins, especially alpha-lactalbumin and beta-lactoglobulin, is denatured.

As shown in the examples below, it appears possible to make a high protein confectionary mass with pleasant taste and mouthfeel with microparticulated whey protein as the sole protein source. Even better confectionary masses are obtained when microparticulated whey protein is combined with WPC or WPI.

It is theorized that the native whey proteins in WPC and WPI better dissolve in the carbohydrate-rich mass that is used for making confectionary masses than the largely denatured whey proteins present in microparticulated whey protein. The latter will have a higher tendency to remain undissolved and absorb the syrup by acting like a kind of sponge. By applying microparticulated whey protein or a combination of microparticulated whey protein and WPC or WPI, confectionary masses with a high protein content and pleasant consistency can be obtained, without requiring proteins other than whey protein.

The confectionary mass according to the present invention is preferably non-caramelized, meaning that it has not been heated in order to caramelize any sugars.

The total protein content of the confectionary mass is preferably in the range 25-50 wt %. more preferably 26-40 wt %, even more preferably 29-38 wt %, and most preferably 32-36 wt %, based on the weight of the confectionary mass.

The protein content of the protein sources is determined using the well-known Kjeldahl nitrogen analysis method and the application of a Kjeldahl factor of 6.38 for dairy proteins.

Essentially all proteins present in the confectionary mass are whey proteins. This means that at least 90 wt %, preferably at least 95 wt %, and most preferably at least 99 wt % of the total protein content is whey protein. In other words, less than 10 wt %, preferably less than 5 wt %, more preferable less than 1 wt % of the total protein content can be a protein other than whey protein.

Whey proteins are defined as the proteins that end up in the whey or serum fraction during cheese manufacturing, caseinate manufacturing, or micellar casein isolation.

The most abundant whey proteins are alpha-lactalbumin, beta-lactoglobulin and, in case of cheese whey, caseinomacropeptide (CMP).

The whey protein content of the confectionary mass is preferably in the range 25-50 wt %. more preferably 26-40 wt %, even more preferably 29-38 wt %, and most preferably 32-36 wt %, based on the weight of the confectionary mass.

The confectionary mass forms the basis of a confectionary product. The confectionary product as a whole, however, may contain one or more additional components—such as visually distinguishable phases, like as crisps or coatings—in addition to the confectionary mass. These additional components can be part of a separate layer on at least part of the (shaped) confectionary mass (e.g. a chocolate or chocolate-containing coating, a yoghurt coating), or they can be dispersed in the confectionary mass. Examples of dispersible components are fruit (concentrate) pieces, nut particles, legume particles (such as peanuts or soy, or (puffed) pieces thereof), cereal particles (e.g. cereal flakes, puffed cereals), caramel, chocolate pieces, chocolate-containing pieces, brownie pieces, protein crisps, etc.

The amount of additional components forming the confectionary product in combination with the confectionary mass is not critical. However, for a high nutritional value, the confectionary mass preferably forms 50-100 wt %, preferably 70-100 wt %, more preferably 80-100 wt %, and most preferably 90-100 wt % of the total weight of the confectionary product.

The water content of the confectionary mass should be relatively low in order to provide a non-fluid mass having at least a dough-like consistency and in order to ensure appropriate shelf-life. The water content is in the range 5-30 wt %, preferably 5-20 wt %, more preferably 10-20 wt %, based on total weight of the confectionary mass.

A confectionary product is made by shaping a confectionary mass, also referred to as a dough, into a desired form. The confectionary product and the confectionary mass are essentially solid at 20° C., meaning that they are self-supporting and essentially maintain their shape when put on a horizontal surface at atmospheric pressure (about 1 bar of air) without further support from the sides or top. The confectionary mass and product are not visibly fluid and may also be referred to as self-sustaining or dimension-stable.

Preferably, the confectionary mass and product according to the invention are self-sustaining at a temperature of 25° C., more preferably at a temperature of 30° C., in particular at a temperature of 35° C. The confectionary mass is, at least during processing, malleable, allowing it to be shaped into a desired form, such as a bar, another geometrical shape or figurine to form a confectionary product. Such malleable mass is generally referred to in the art as a dough, or—if intended for the production of a protein bar—as a protein bar dough. The confectionary mass can thus be used as the matrix of a protein bar. Herein other food materials can be dispersed. The shaped mass can be left uncoated or form the core of a coated food product, such as a coated protein bar.

The confectionary mass according to the present invention further comprises a binding material, preferably selected from carbohydrates and sugar alcohols. Suitable binding materials are monosaccharides, disaccharides, oligosaccharides, polysaccharides, polyols, sugar alcohols, steviol glycosides, and combinations thereof. Specific examples of binding materials are glycerol, fructo-oligosaccharides (FOS), galacto-oligosaccharides (GOS), glucose-fructose syrup, tapioca syrup, maple syrup, brown rice syrup, isomaltofructose, maltitol, sorbitol, erythritol, and combinations thereof.

The binding material is present in the confectionary mass in a concentration of 25-80 wt %, more preferably 30-70 wt %, and most preferably 40-60 wt %.

The confectionary mass further contains vegetable oil. The presence of oil is desired for its effect on texture and/or mouthfeel. It acts as a plasticizer and in particular contributes to a smoother mouthfeel. Examples of suitable oils are palm oil, palm kernel oil, olive oil, rapeseed oil, sunflower oil, coconut oil, and medium chain glycerides (MCT oil). MCT oil may be a fraction of any of the above mentioned oils that is enriched in medium chain triglycerides (C6-C12). Coconut oil is a preferred oil as it is capable of providing a good taste to the confectionary product.

The oil is present in the composition in a concentration of 5-20 wt %, preferably 5-15 wt %, most preferably 5-10 wt %.

In addition, the confectionary mass may contain flavourings, e.g. chocolate flavour, and additives like sucralose, lecithin, thickening agents (e.g. carboxymethylcellulose, xanthan gum), seeds (e.g. chia seeds), and stabilizers (e.g. carrageenan).

In addition, it may be desired to add a carbonate or bicarbonate salt, preferably sodium bicarbonate, as a processing aid.

The confectionary mass can be made in conventional ways by mixing the protein source(s) with the other ingredients, for instance by using a Z-blade mixer. In a preferred embodiment, the protein powder(s) and any other solid ingredients, individually or as a blend, are added to and subsequently mixed with a liquid phase. This liquid phase usually comprises water, which may be added or be part of the carbohydrate syrup. This facilitates mixing with the protein powders when added.

The water content should be relatively low in order to provide a non-fluid mass having at least a dough-like consistency, i.e. in the range 5-30 wt. %, preferably 5-20 wt %, more preferably 10-20 wt. %, based on total ingredients. The lipid, in particular triglyceride, is usually dispersed in the liquid phase comprising water. An emulsifier is generally not needed, in particular not if the liquid phase is prepared at a temperature at which the lipid is fluid. If used, preferably lecithin is used, which has been found to have a positive effect on smoothness of the mass. The liquid phase further typically comprises the binding material (carbohydrate or sugar alcohol). Glycerol is a carbohydrate that is liquid at room or processing temperature. A binding material that is solid at room or processing temperature, or part thereof, is advantageously provided as a syrup. Such syrup may provide all the water that is desired.

The liquid phase is preferably prepared at a temperature in the range of 20-75° C., preferably 45-65° C., in particular about 60° C., or brought to a temperature in that range, after which the protein powder(s) are mixed into the liquid phase, to obtain the confectionary mass. If desired, pieces of other food materials (e.g. nuts, chocolate, cereal, fruit) can also be added to the liquid at this stage, before, together with or after adding the protein powders.

An example of a confectionary product that can be made from the confectionary mass is a food bar.

The confectionary mass preferably constitutes at least 50 wt %, more preferably at least 70 wt %, even more preferably at least 80 wt %, and most preferably at least 90 wt % of the weight of confectionary product, the confectionary mass preferably either forming a matrix having other food materials dispersed therein—such as fruit (concentrate) pieces, nut particles, (puffed) legume particles, (puffed) cereal particles, caramel, chocolate pieces, chocolate-containing pieces, brownie pieces, and/or protein crisps—or forming part of a core that is a covered by a coating.

This confectionary product can be shaped in a desired form in a manner known per se. The confectionary mass can be shaped into any geometrical shape. Various shaping methods can be applied, including rolling, extruding, depositing and removing from refrigerated drums, pressing, moulding, and the like. The confectionary mass has a dough-like consistency and is non-fluid but deformable at ambient temperature, at least until after having been shaped into a desired form, such as a bar. After having been shaped, the consistency of the mass may change.

After shaping, the confectionary product may be coated, for instance with chocolate, a chocolate-containing coating, a yoghurt coating, or the like.

### EXAMPLES

### Determination of the Protein Content

The protein content of a powdered dairy protein source was determined by the Kjeldahl method (Nx6.38).

### Example 1

A Z-blade mixer with the double-walled jacket was pre-heated to 60° C. The liquid ingredients-oil, glycerol, carbohydrate syrup-were heated to 70° C. and subsequently added to the Z-blade mixer. The protein powder(s) were added to the mixer and all ingredients were mixed at maximum speed till a cohesive dough was formed.

The resulting dough was rolled on a tray, stored at 4° C. overnight, and cut into bars.

The bars were packed individually and stored at 20° C.

The following protein powders were used:
WPC80—a whey protein concentrate with a 80 wt % protein content (Nutri Whey™ 800F, ex-FrieslandCampina)
WPI—a whey protein isolate with a 90 wt % protein content (Nutri Whey Isolate, ex-FrieslandCampina)
Microparticulated whey protein—Fonterra Sure™ Protein 515 and Fonterra Sure™ Protein 550

The bars contained, based on dry weight, one or more plant protein powder source(s) to achieve a protein content of 35 wt %, 5 wt % MCT oil, and 5 wt % glycerol; the remainder being glucose-fructose syrup. The water content was in the range 10-14 wt %.

The texture and sensory of these bars was evaluated by a group of experts; both directly after preparation (‘fresh’) and after one month of storage at room temperature (‘1m’).

### Explanation of the Ratings:

### Texture:

1a: cohesive, but extremely soft
1b: non-cohesive; too powdery
1c: extremely hard
2: soft, powdery, hard
3: cohesive, but a little powdery, and/or hard
4: good cohesiveness; pleasant bite

### Sensory:

1: Strong off-taste and/or powdery mouthfeel
2: Little off-taste
3: no off taste
4: Very pleasant taste and mouthfeel

Table 1 shows the texture and sensorics of bars made with only one protein source. It shows that acceptable bars cannot be made with 100% whey protein concentrate or isolate, but can be made with microparticulated whey protein as the sole protein source.

TABLE 1

| Protein | | Protein | | Texture | Sensory | Texture | Sensory |
|---|---|---|---|---|---|---|---|
| source 1 | % | source 2 | % | fresh | fresh | 1m | 1m |
| — | 0 | WPC80 | 100 | 1c | 1 | nd* | nd* |
| — | 0 | WPI | 100 | 2 | 1a | 2 | 1a |
| MPW 550 | 100 | — | — | 3 | 2 | 2 | 2 |
| MPW 515 | 100 | — | — | 3 | 3 | 2 | 2 |

*nd = not determined as a bar could not even be made

Table 2 shows the texture and sensorics of bars made with combinations of whey protein sources. This table clearly shows that bars according to the invention have better texture and sensorics than comparative bars.

TABLE 2

| Protein | | Protein | | Texture | Sensory | Texture | Sensory |
|---|---|---|---|---|---|---|---|
| source 1 | % | source 2 | % | fresh | fresh | 1m | 1m |
| MPW 515 | 30 | WPI | 70 | 2 | 2 | 2 | 2 |
| MPW 515 | 55 | WPI | 45 | 4 | 4 | 4 | 4 |
| MPW 515 | 70 | WPI | 30 | 4 | 4 | 4 | 4 |
| MPW 515 | 10 | WPC80 | 90 | 1c | 1 | 1c | 1 |
| MPW 515 | 30 | WPC80 | 70 | 2 | 2 | 2 | 2 |
| MPW 515 | 55 | WPC80 | 45 | 3 | 3 | 3 | 3 |
| MPW 515 | 70 | WPC80 | 30 | 4 | 4 | 4 | 4 |
| MPW 515 | 90 | WPC80 | 10 | 3 | 3 | 3 | 3 |

* nd = not determined as a bar could not even be made

1: Confectionary mass comprising:
10-70 wt % of one or more whey protein sources,
25-80 wt % of a binding material, preferably selected from carbohydrates and sugar alcohols, and
5-20 wt % of oil, preferably vegetable oil,
wherein the total water content of the confectionary mass is in the range 5-30 wt %, less than 10 wt % of the total protein content may be a protein other than whey protein, and wherein the whey protein sources are selected from whey protein concentrate, whey protein isolate, hydrolysed whey protein, and microparticulated whey protein, and wherein 30-100 wt % of the one or more whey protein sources is microparticulated whey protein.

2: Confectionary mass according to claim 1 wherein the whey protein sources are selected from whey protein concentrate, whey protein isolate, and microparticulated whey protein.

3: Confectionary mass according to claim 1 wherein 40-90 wt %, preferably 50-80 wt %, more preferably 55-75 wt %, most preferably 60-75 wt % of the one or more whey protein sources is microparticulated whey protein.

4: Confectionary mass according to claim 1 having a total protein content in the range 25-50 wt %, preferably 26-40 wt %, more preferably 29-38 wt %, and most preferably 32-36 wt %, based on the weight of the confectionary mass.

5: Confectionary mass according to claim 1 wherein the whey protein content is the range 25-50 wt %, preferably 26-40 wt %, more preferably 29-38 wt %, and most preferably 32-36 wt %, based on the weight of the confectionary mass.

6: Confectionary mass according to claim 1 comprising 40-60 wt % of the binding material.

7: Process for preparing a confectionary mass comprising 10-70 wt % of one or more whey protein sources, 25-80 wt % of a binding material, preferably selected from carbohydrates and sugar alcohols, and 5-20 wt % of oil, preferably vegetable oil, the confectionary mass having a total water content in the range 5-30 wt % and less than 10 wt % of the total protein content may be a protein other than whey protein, the process comprising the step of blending the one or more whey protein sources with the binder and the oil, wherein the one or more whey protein sources are selected from whey protein concentrate, whey protein isolate, hydrolysed whey protein, and microparticulated whey protein, and wherein 30-100 wt % of the one or more whey protein sources is microparticulated whey protein.

8: Process according to claim 7 wherein the whey protein sources are selected from whey protein concentrate, whey protein isolate, and microparticulated whey protein.

9: Process according to claim 7 wherein 40-90 wt %, preferably 50-80 wt %, more preferably 55-75 wt %, most preferably 60-75 wt % of the one or more whey protein sources is microparticulated whey protein.

10: Process according to claim 7 wherein the confectionary mass has a total protein content in the range 25-50 wt %, preferably 26-40 wt %, more preferably 29-38 wt %, and most preferably 32-36 wt %, based on the weight of the confectionary mass.

11: Process according to claim 7 wherein the whey protein content of the confectionary mass is the range 25-50 wt %, preferably 26-40 wt %, more preferably 29-38 wt %, and most preferably 32-36 wt %, based on the weight of the confectionary mass.

12: Process according to claim 7 wherein the confectionary mass comprises 40-60 wt % of the binding material.
